(19) United States
(12) Patent Application Publication
(10) Pub. No.: US 2015/0134484 A1
(43) Pub. Date: May 14, 2015

(54) ONLINE REAL ESTATE TRANSACTION SYSTEM

(71) Applicant: Allre, Inc., San Diego, CA (US)

(72) Inventors: Katherine Dryden, San Diego, CA (US); Dave Mercer, Spring Valley, CA (US)

(21) Appl. No.: 14/463,610

(22) Filed: Aug. 19, 2014

Related U.S. Application Data
(60) Provisional application No. 61/868,932, filed on Aug. 22, 2013.

(51) Int. Cl. G06Q 50/16; G06Q 30/06

(52) U.S. Cl. CPC G06Q 50/167; G06Q 30/0613; G06Q 30/0635
USPC 705/26.41

(57) ABSTRACT

An online purchase transaction system facilitates commencement, listing, selection, negotiation, documenting, closing and recording of complex transactions. The system allows for completion of transactions, such as commencement of a real estate listing through transfer with minimal or no direct third-party human intervention, thus maximizing cost savings and minimizing time to complete a transaction. Interaction through third party agencies, such as escrow companies, title companies, insurance companies and recording entities, is further facilitated in a fully or largely automated processing system.

### TECHNICAL FIELD

The subject application includes embodiments directed generally to online transactions, and more particularly to online sales transactions. The application includes an embodiment directed to online real estate sales that avoids use of a sales agent.

### BACKGROUND

Buying and selling transactions, particularly those involving substantial assets such as real estate transactions, are typically very complicated and time consuming. There is an entire industry of real estate professionals that derive income from real estate transactions, including agents, attorneys, insurers, and the like. Inclusion of any human resources adds significant expense, delay and complexity to transactions.

### BRIEF DESCRIPTION OF THE DRAWINGS

FIG. 1 illustrates a flowchart of an embodiment of the subject application;

FIG. 2 illustrates an example user profile;

FIG. 3 illustrates an embodiment for facilitating a listing input;

FIG. 4 illustrates an embodiment for facilitating a listing input;

FIG. 5 illustrates an example of a display showing information related to other comparable homes in the area and the value and/or listing price of such homes.

FIG. 6 illustrates an example of a display showing information related to properties which the seller has listed for sale;

FIG. 7 illustrates an embodiment for facilitating a scheduling operation;

FIG. 8 illustrates an embodiment for facilitating location of a property of interest;

FIG. 9 illustrates a detailed description for a property of interest;

FIG. 10 illustrates an embodiment for purchasing a property of interest;

FIG. 11 illustrates an example of an instant purchase confirmation display;

FIG. 12 illustrates an embodiment for facilitating negotiation;

FIG. 13 illustrates an embodiment for facilitating negotiation;

FIG. 14 illustrates an embodiment for facilitating a real estate transaction;

FIG. 15 illustrates an embodiment for facilitating a real estate transaction;

FIG. 16 illustrates an embodiment for facilitating a real estate transaction; and

FIG. 17 illustrates an embodiment for facilitating a real estate transaction.

### OVERVIEW OF EXAMPLE EMBODIMENTS

The subject application teaches an embodiment wherein is the online site allows buyers and sellers to complete an entire real estate transaction online without the use of an agent. The site suitably compounds all of the documents, disclosures, negotiation between parties, timeline of the process and coordination of closing in one place.

The subject application teaches an embodiment inclusive of a fully-automated or predominantly automated system to accomplish listing, viewing and purchasing operations. The teachings are particularly applicable to real estate transactions that are implemented through networked computers, such as via a wide-area-network or the Internet.

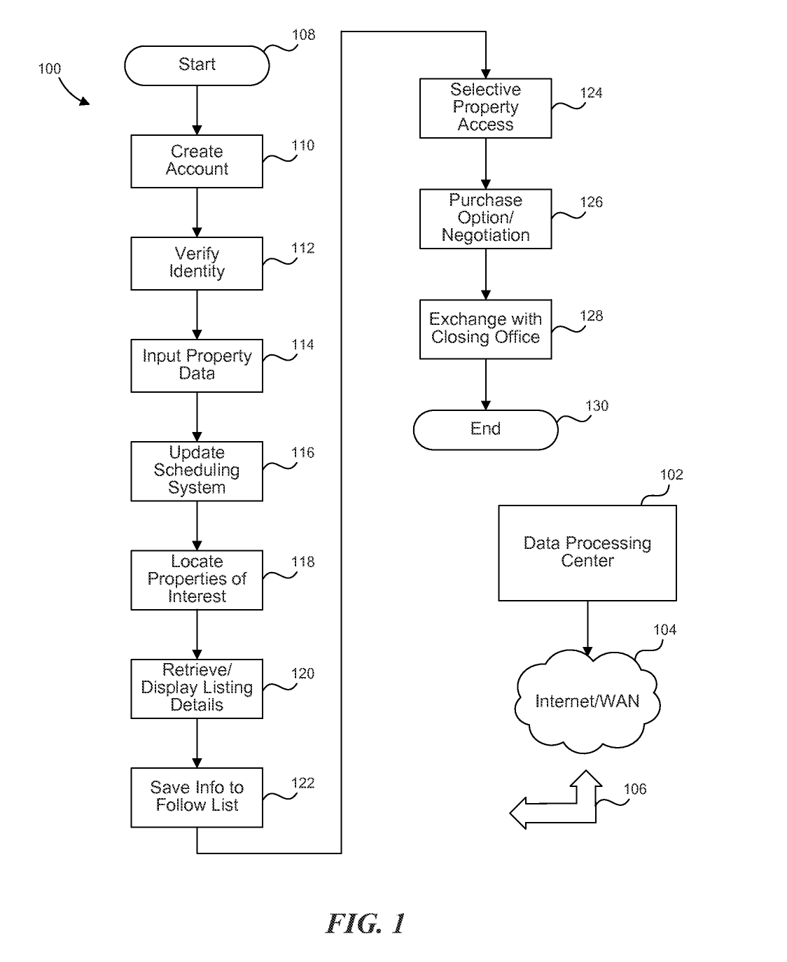

Turning to FIG. 1, a transaction 100 is suitably accomplished via an interface to a data processing center 102 through a data network such as a wide-area network or Internet 104. The transaction 100 is suitably completed via a web browser and Internet connectivity 106 as will be appreciated by one of ordinary skill in the art.

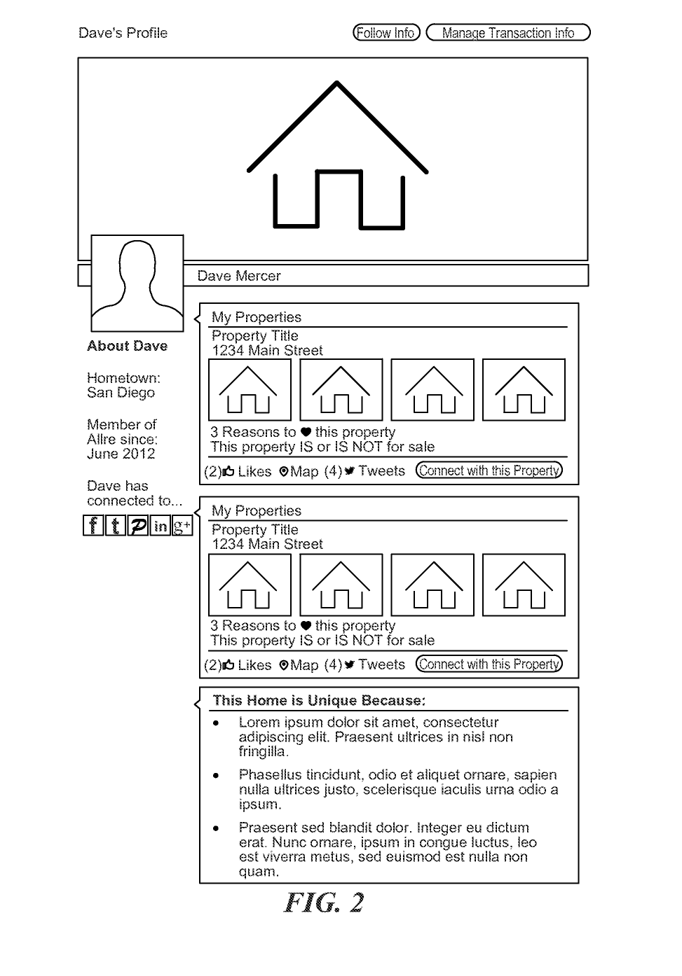

Transaction 100 starts at block 108. An account is created at 110 for a user of the system, which account suitably includes information such as a username, password and identification information. The account may suitably be created for a buyer, a seller, or other interested party. They can suitably login directly to a data system. In alternative embodiments, login is suitably accomplished via a social media portal, such as Facebook or Twitter. Once login credentials are suitably established, a user suitably creates their profile. Next, at block 112, verification is made of the user, suitably via use of available confirmatory information from financial institutions, public records, third-party verification, and the like. When a buyer creates their profile, they are suitably informed that in order to schedule any showings or make an offer to purchase, their identity needs to be verified via two methods. Qualifying is suitably accomplished with an approved lender or through an online identity verification company. Once verification has taken place, they will be able to make offers and schedule showings. The identity of the seller is not verified until such as the seller lists a property for sale on the system. Both the buyer and seller have a public and private profile page. The private profile houses the information about the properties they own, their login information and the various social networks and online verification of identity prompts. The public profile shows this information to other users on the website and from the profile page a user can message another user about a property they own. An example of a profile is illustrated in FIG. 2.

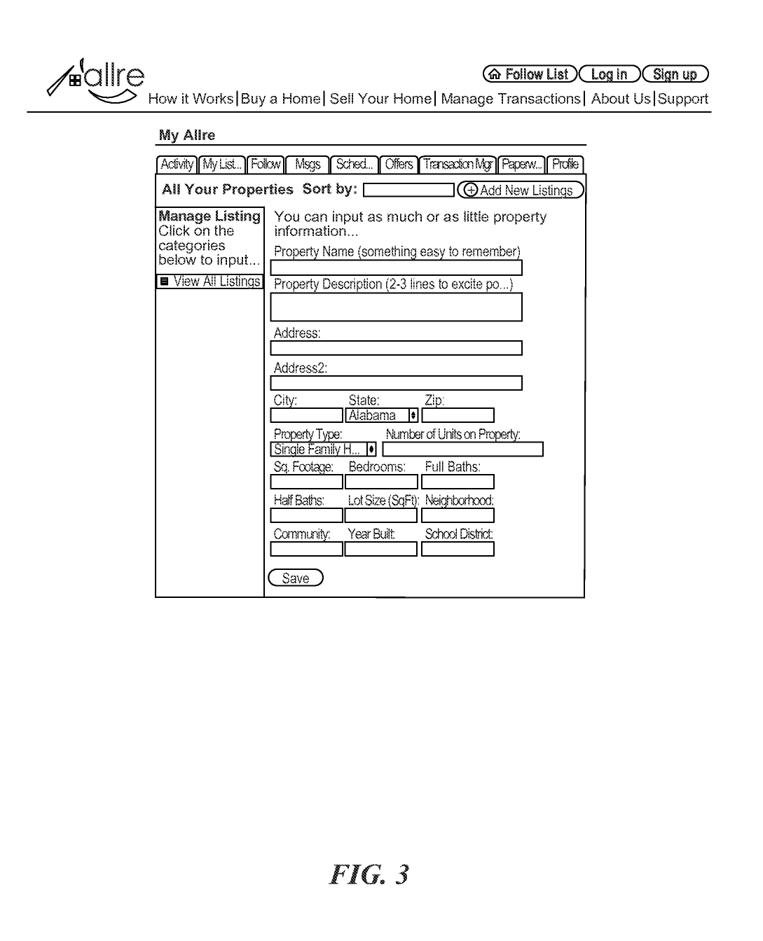

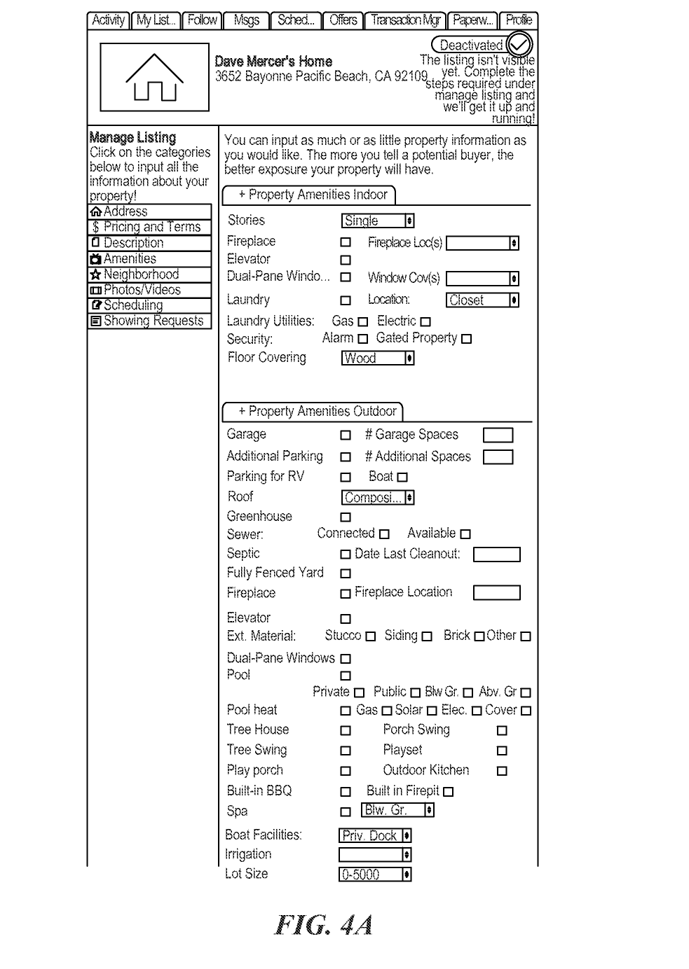

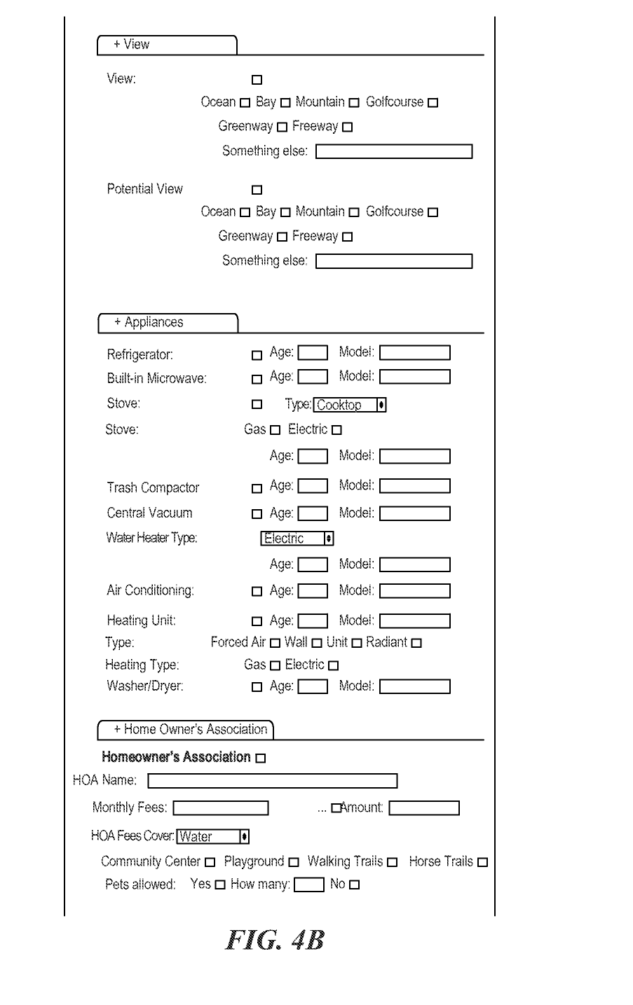

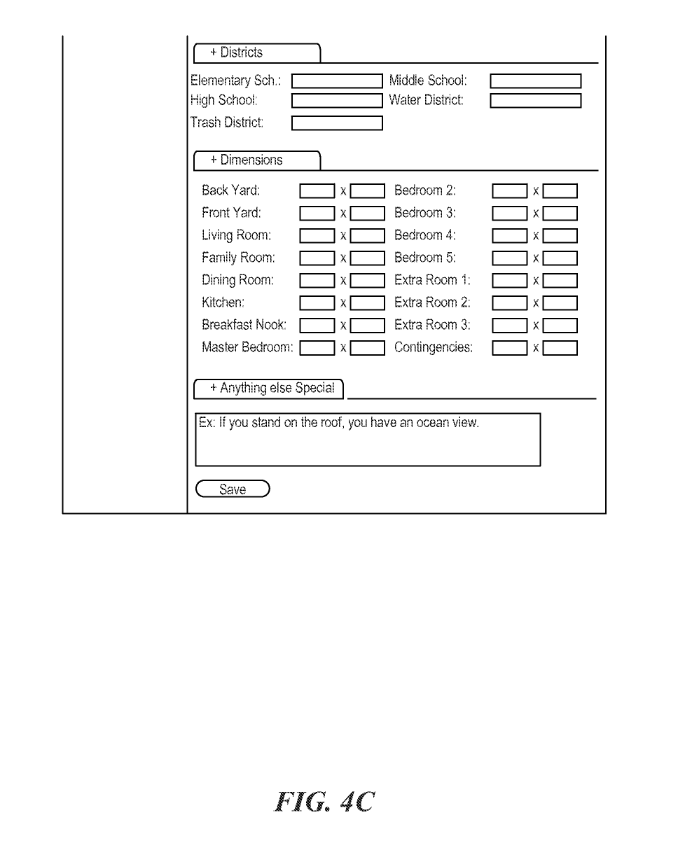

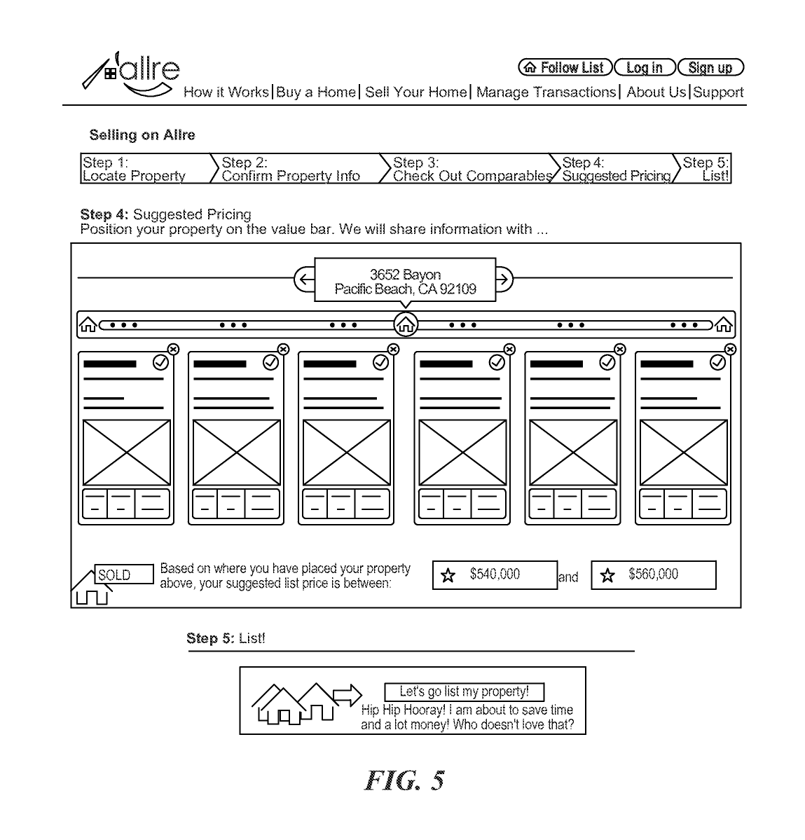

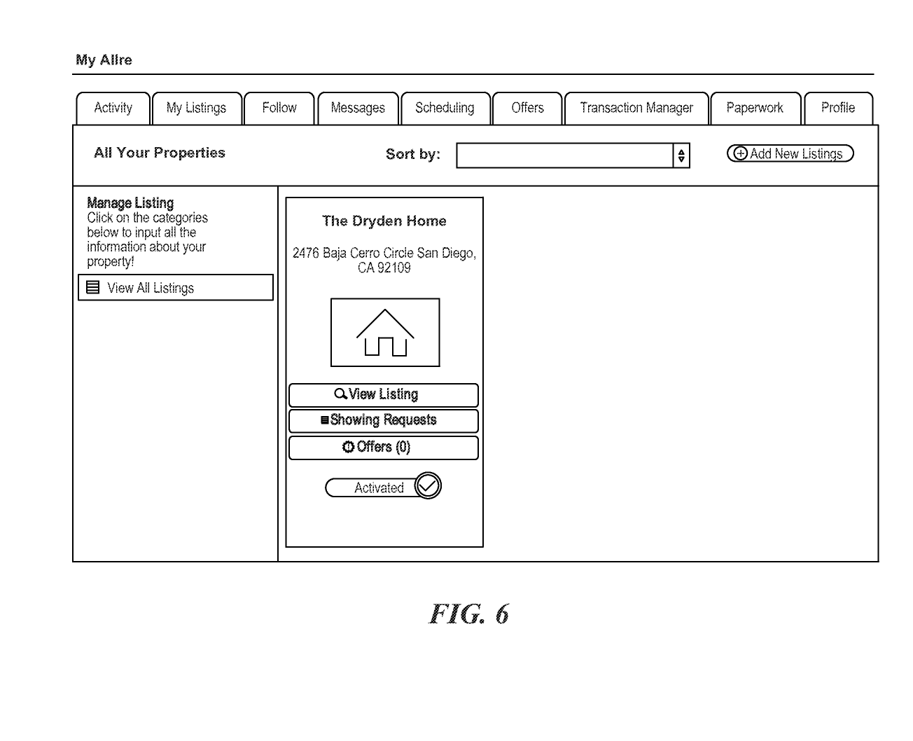

Next, at block 114, the seller suitably inputs their property information. The seller is suitably provided with an ability to list their home for sale or simply connect to their home and add information, but not put it for sale. Once a property is activated for sale, the seller has the ability to input as much or as little information about their home as they wish. See, FIGS. 3-4. The information they input suitably includes property details, which may be imported from public records, pictures, videos, amenities, upgrades and a personalized showing calendar of when the property is available for a visit or open house. The seller also inputs their “Instabuy” terms which include all negotiated terms that happen in a real estate contract. These include; purchase price, deposit, closing date, credits and/or repairs offered and appliances that stay with the home. The system may suitably provide suggested pricing for the sale by providing information on houses with comparable features or for sale in the area. An example of such a display is illustrated in FIG. 5. These terms are the listing terms for the property and also serve as the terms that a buyer can agree to immediately to purchase the property right away without negotiation. The seller may suitably provide information for any number of properties that the seller wishes to sell. The system suitably provides a display showing all of the seller's properties listed thereon as illustrated by FIG. 6.

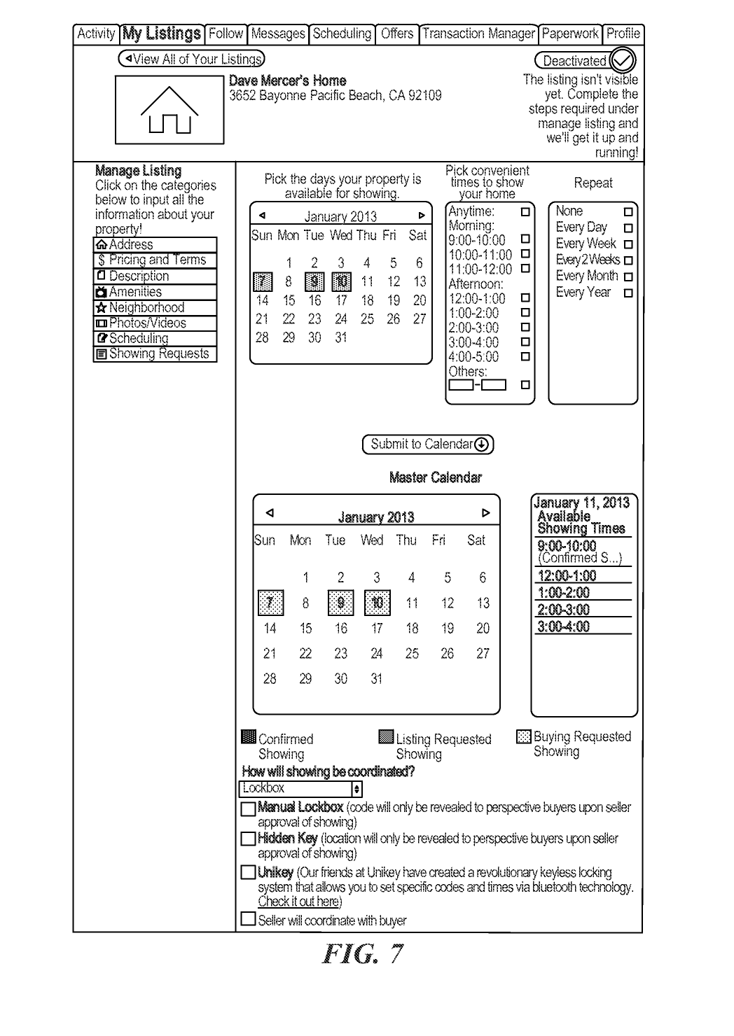

The subject system advantageously provides a unique scheduling system at 116 that allows the seller to select the times that their property is available to show and the times the property will be open for an open house, which is then translated onto a master calendar that the buyer can see and schedule accordingly. All showings are kept on one master calendar for both the buyer and seller to access. The buyer can make a showing request during a time that seller has inputted an open spot and the seller has the option to accept, reject or request a re-schedule of the buyer's request. See, by way of example, FIG. 7.

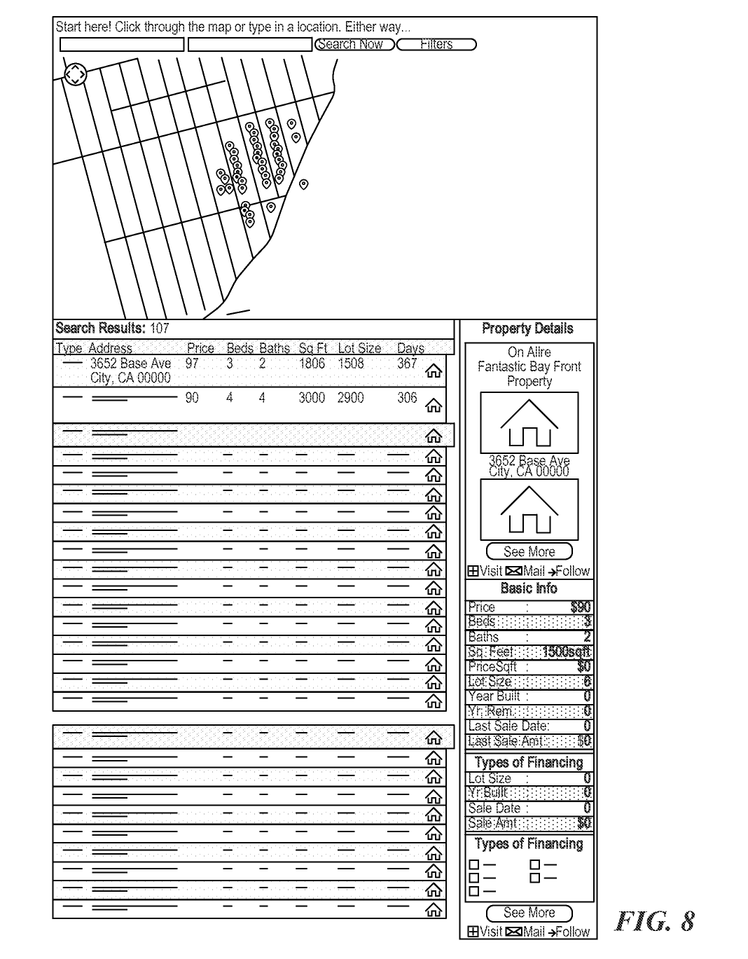

Next, at 118, a buyer suitably locates properties they are interested in viewing or buying via the search page. See, by way of example, FIG. 8. The properties are shown on a map as well as in list view with the details of the property populated on the right side of the page as the buyer clicks on the map markers or listings in the list view.

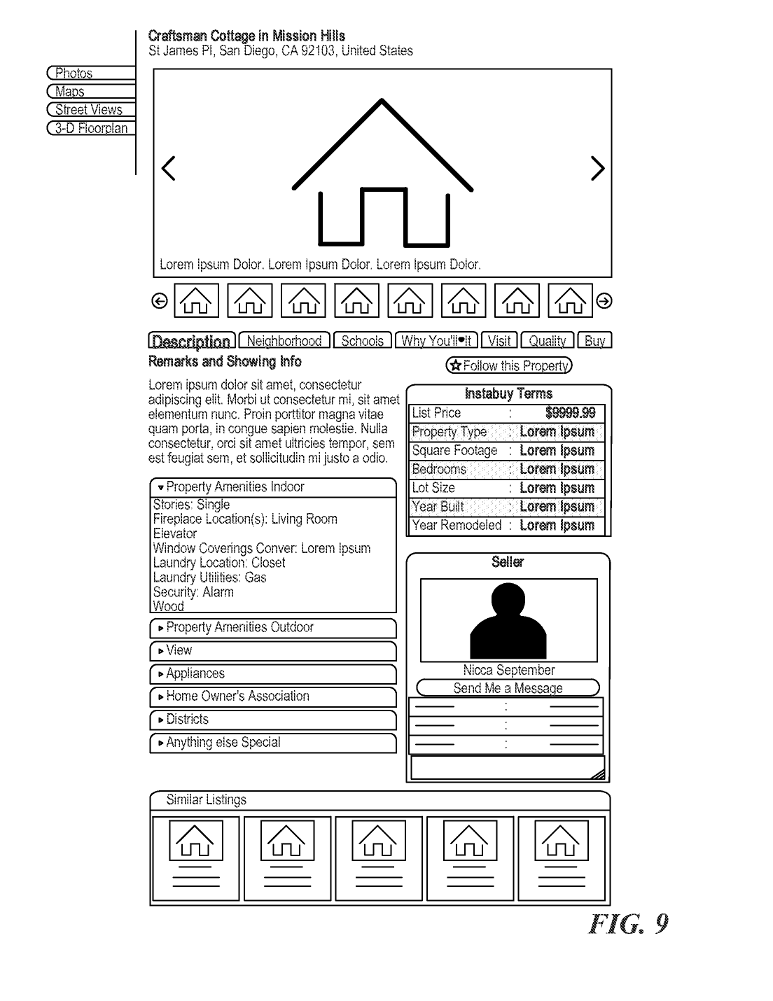

Next, at 120, listing details are suitably retrieved. A listed property has a display which gives users access to the following information: Photos, Maps, Description, Local Schools, Neighborhood Information, Qualify with a lender for this house, Schedule a visit, Buy the property. See, by way of example, FIG. 9.

Next, at 122, transaction information is suitably stored for further use or retrieval. In accordance with the forgoing, once a buyer has found a property they are interested in, they are enabled to suitably save it to their “follow” list. They are then enabled schedule a viewing or proceed toward a purchase. They can schedule a visit or make an offer without “following” the property. If they schedule a showing or make an offer, the property is automatically placed in their follow list.

Next, at 124, a seller suitably grants access to the property in several ways. By way of example, such would include:

Meeting the buyer, optionally with scheduling of the same;

Telling a buyer where a hidden key is located;

Giving the buyer a code to a stationary lockbox; or

Giving the buyer access to a smart lockbox that the seller has purchased through the website.

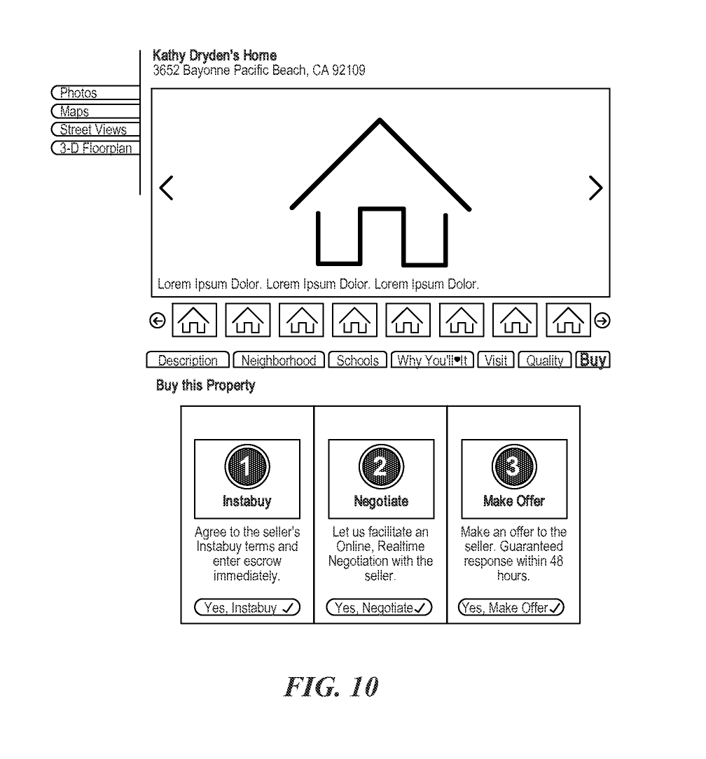

Other Special Instructions are suitably provided. Buyer chooses which property they would like to make an offer on by selection one of several options, as illustrated in FIG. 10. Next, at 126, purchase and/or negotiation is suitably accomplished.

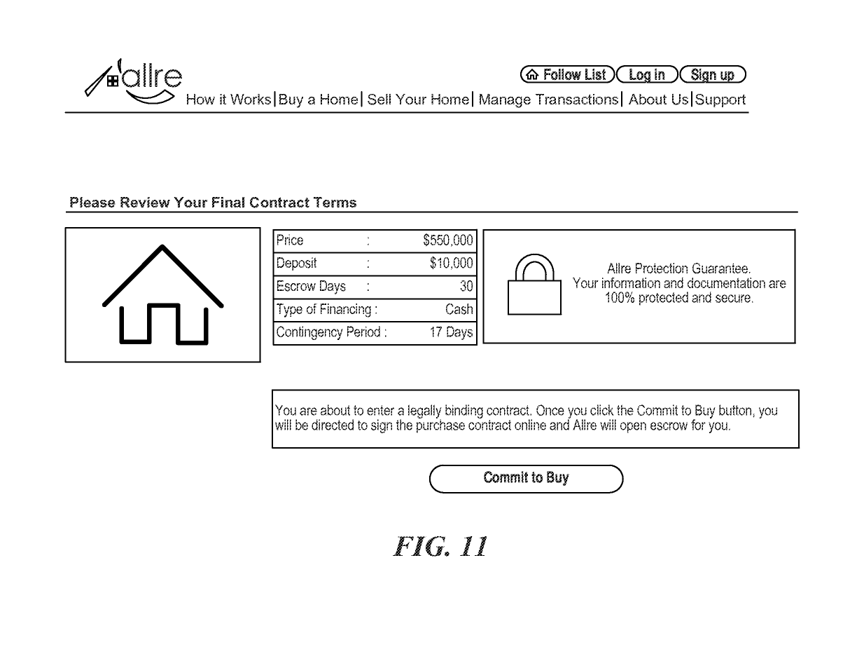

A seller is enabled to list their property inclusive of terms for immediate purchase. Which are the terms that they pre-agree to will sell their property upon acceptance. If the buyer accepts these terms, they simply accept the terms, such as via an acceptance click, at which point they are suitably directed to a contract where they sign and open escrow on the property. See, by way of example, FIG. 11

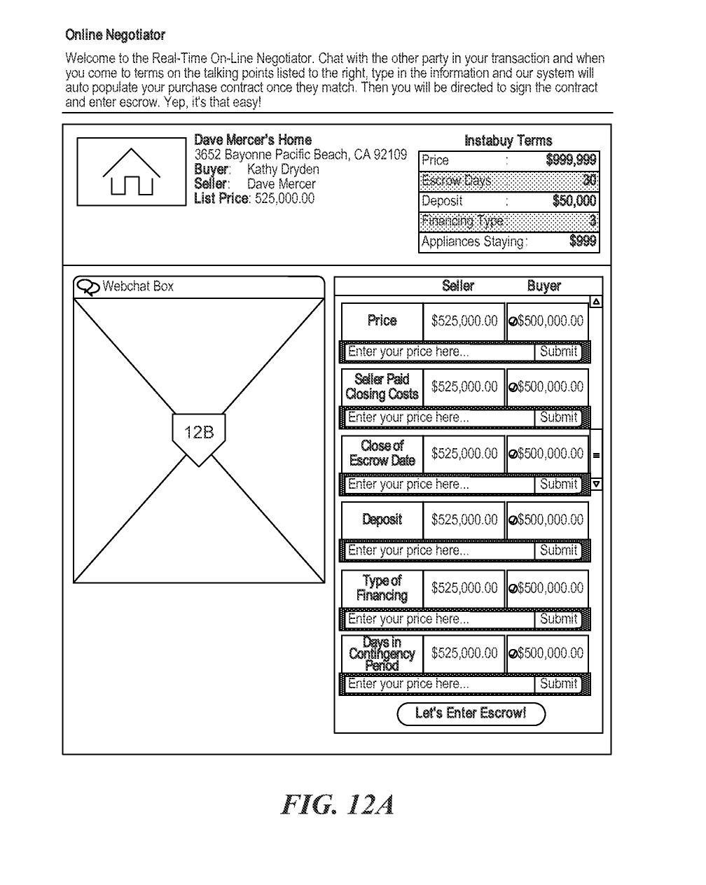

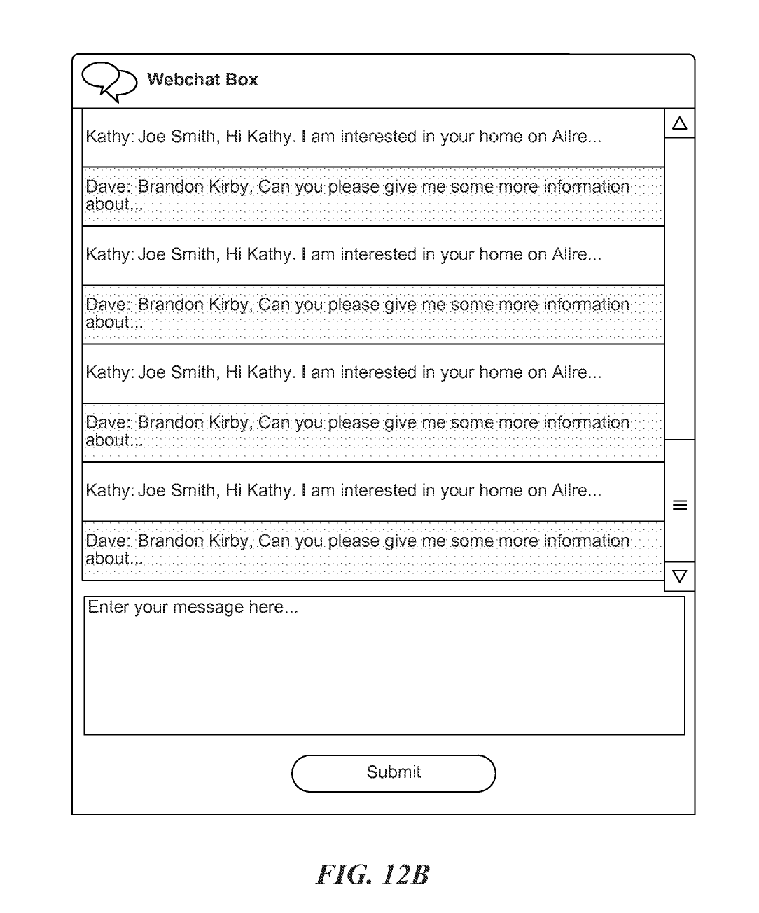

Another option is an online negotiation process. In such a process, Buyer and Seller suitably agree on a time to real-time chat and negotiate their deal. The seller's terms for instant purchase are suitably displayed as a starting point for negotiations, and there are suitably additional categories outlining what to discuss in the chat. Once buyer and seller agree on a term, they both input those terms and when they match, the system gives them a green arrow to move onto the next item. Once all of the items have been negotiated, they are both sent to the contract, which is pre-filled with their appropriate terms and prompted to sign the contract and enter escrow. See, by way of example, FIG. 12.

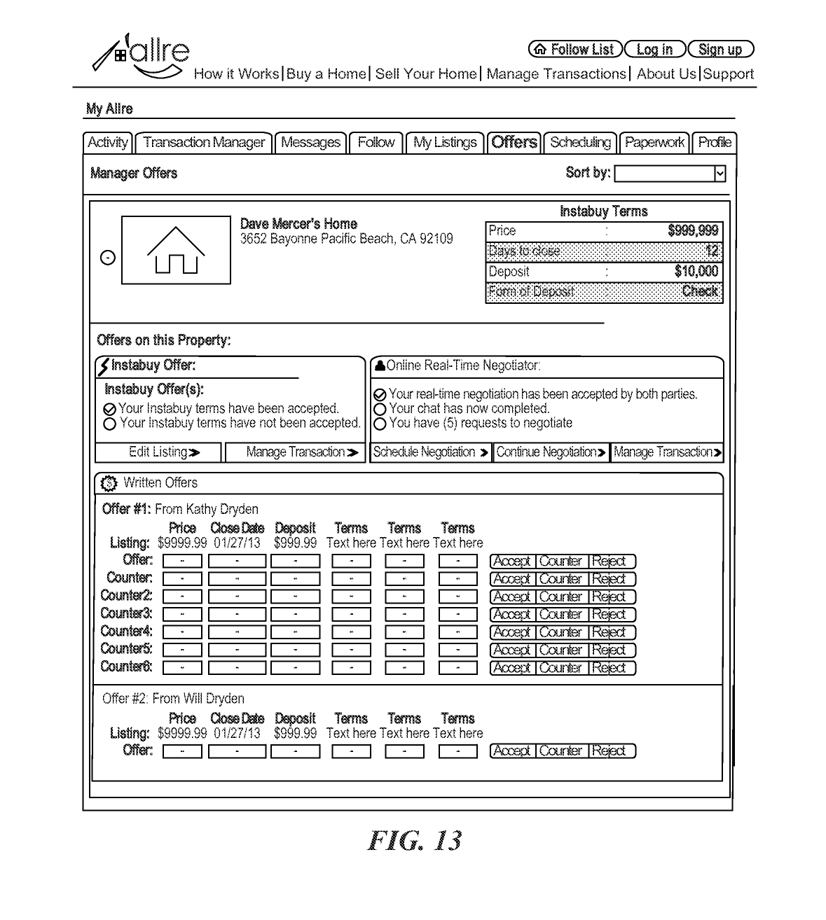

In yet another option, buyers are provided with an ability to submit an offer. Buyers are suitably given a simple form to fill out with the negotiable terms, seller can counter, reject or accept an offer, as illustrated in FIG. 13. Once it is accepted, the contract is automatically filled out by and buyer and seller are prompted to sign and escrow is opened.

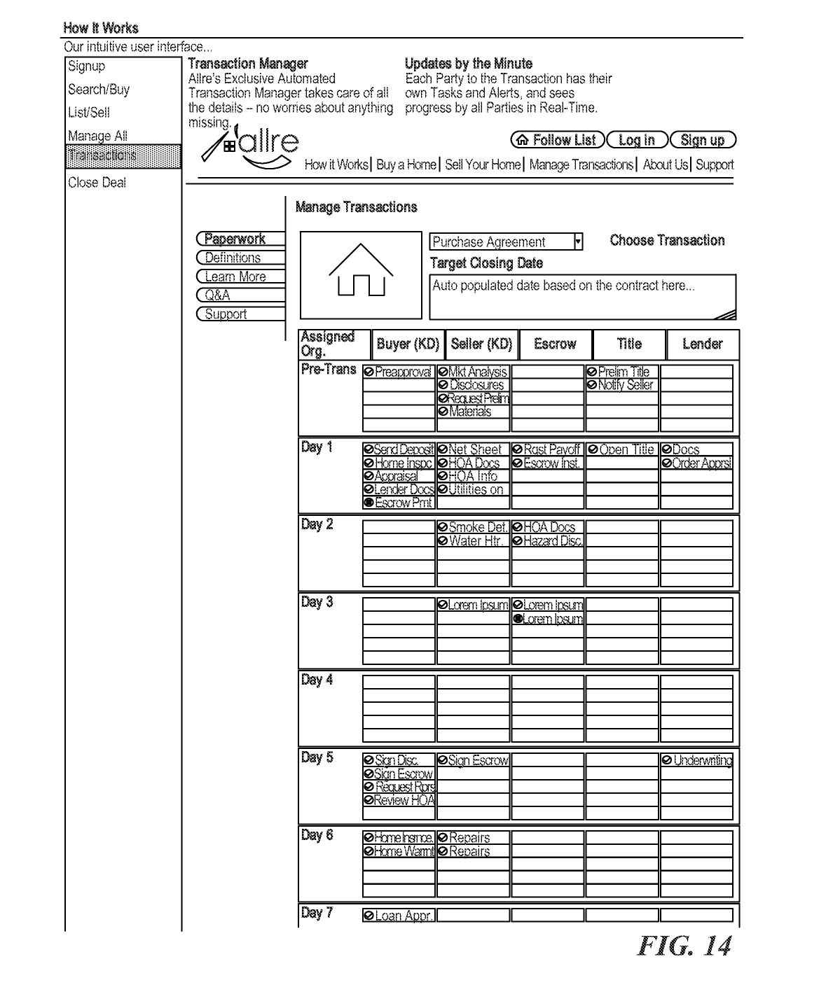

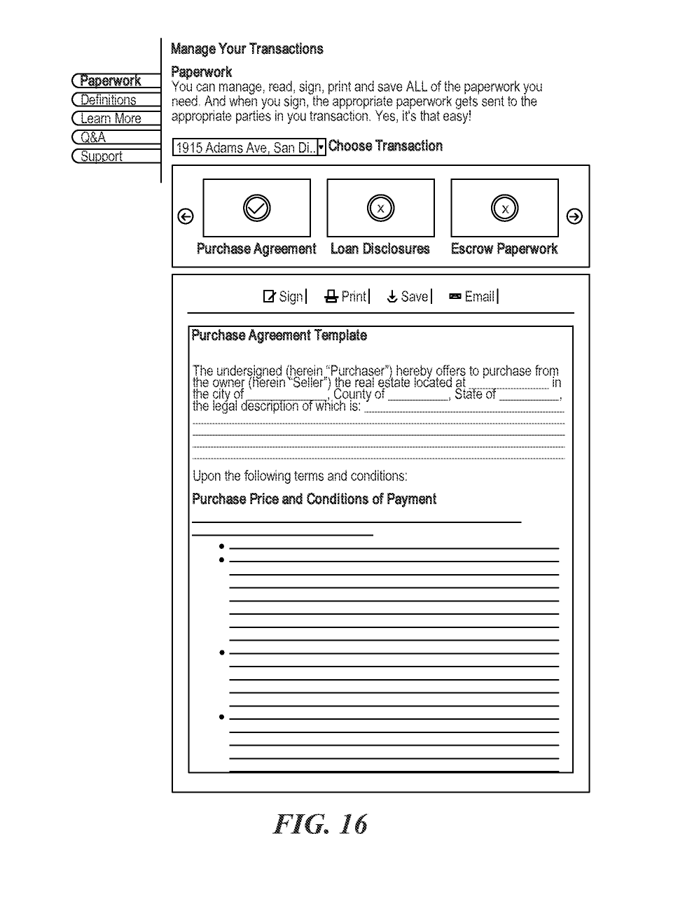

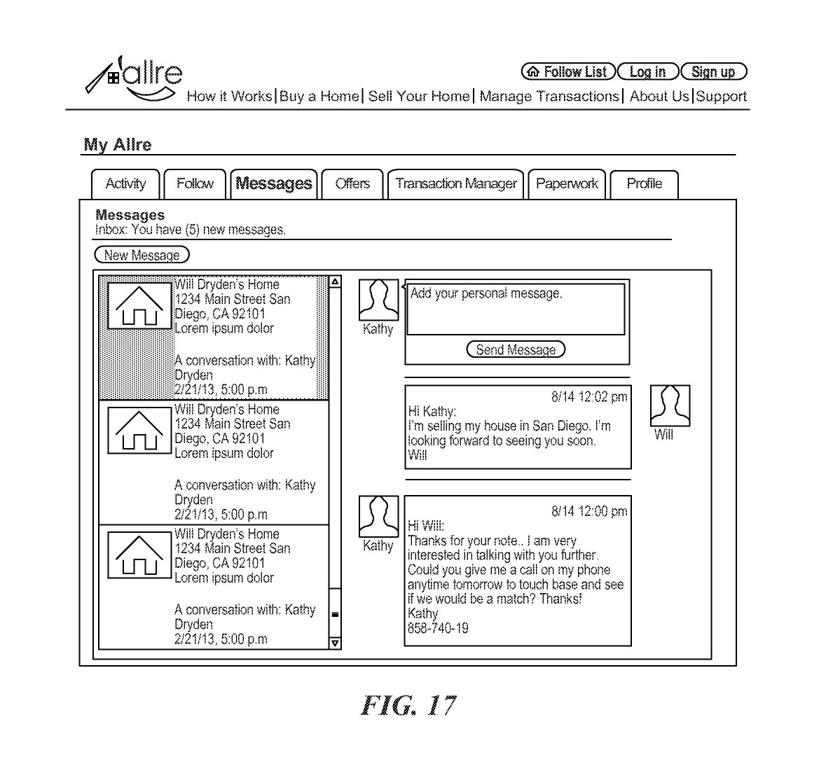

In accordance with the forgoing, transactions are commenced, progress and are tracked through a massively automated system. Management and viewing of transactions are facilitated, as are generation of agreements and forms. See FIGS. 14-17.

The subject system suitably sends the contract and transaction information to a suitable closing office who logs into a custom built backend system and assigns the file to a closing office within 30 miles or 30 minutes of the property, such as provided at 128.

The entire transaction is then advantageously projected against a timeframe, such as a 10 day timeframe for closing. Buyer, Seller, Title, Escrow, Lender and Attorney all have a column on the chart detailing their tasks on a daily basis.

Each party in the transaction is suitably sent a periodic reminder, such as a daily email with denoting tasks for the day. If tasks are not completed on time, the subject system will advantageously facilitates send another email and/or a text message reminder.

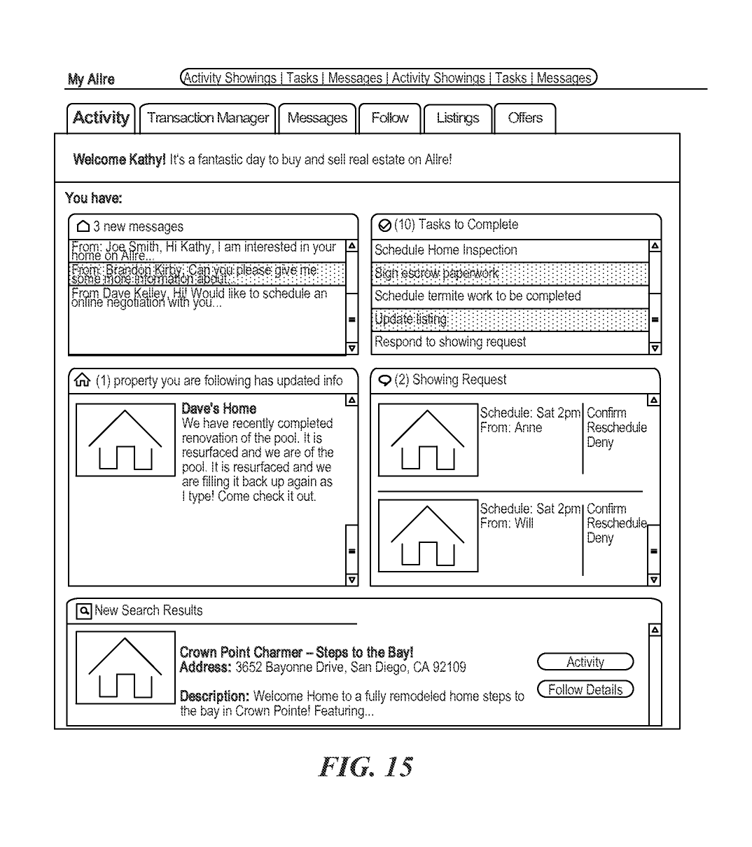

The subject system facilitates easy viewing of summary information with a snapshot everything that is going on with their listings, potential purchases and transactions, as particularly evidenced by FIG. 15

Advantageously, the subject system suitably enables required documentation, such as that needing to be signed as well as reports that need be uploaded into the file, to occur at a backend location. Therefore, on the user side, the user sees the tasks displayed specifically for them and can also see the tasks displayed for each party in order to create an advantageous system of checks and balances.

Once all tasks have been completed, the transaction is able to close escrow. The closing is reported to the subject system by a closing office, the system advantageously stores the associated file for selected period, such as a period of seven years, for all users to go back and access if need-be, and the process suitably terminates at 130.

It is claimed:

1. An automated transaction system comprising:
a data processing system in data communication with a network; and
a plurality of data terminals in data communication with the data processing system via the network, each of the plurality of terminals being operable to, while in data communication with the data processing system,
create a user account for an associated user operating at a terminal,
verify a user identity in accordance data associated with a user account,
receive and store data corresponding to a real estate property associated with the user,
generate a sales schedule with the real estate property,
receive search data corresponding to a desired property for purchase,
complete a search in accordance with received search data so as to generate a candidate list,
receive selection data to generate a follow list in accordance with selected items of the candidate list,
generate access data to facilitate third party access to the real estate property, moderate a purchase dialog between a seller and a purchaser,
communicate legal documents associated with closing a real estate transaction, and
exchange transaction information with an associated closing office.

2. A transaction method comprising:
creating a user account for an associated user operating at a terminal in network data communication with a data processing system;
verifying a user identity in accordance data associated with a user account;
receiving data corresponding to a real estate property associated with the user;
storing received data in an associated data storage;
generating a sales schedule with the real estate property;
receiving search data corresponding to a desired property for purchase;
completing a search in accordance with received search data so as to generate a candidate list;
receiving selection data to generate a follow list in accordance with selected items of the candidate list;
generating access data to facilitate third party access to the real estate property;
moderating a purchase dialog between a seller and a purchaser;
communicating legal documents associated with closing a real estate transaction; and
exchanging transaction information with an associated closing office.
